(19) United States
(12) Patent Application Publication
(10) Pub. No.: US 2007/0203022 A1
(43) Pub. Date: Aug. 30, 2007

(54) Metal Oxide Catalyst And Method For The Preparation Thereof

(75) Inventors: Robert Schlogl, Berlin (DE); Olaf Timpe, Berlin (DE); Sharifah Bee Binti O A Abd Hamid, Petaling Jaya Selangor (MY); Dirk Niemeyer, Brunsbuttel (DE); Stefan Knobl, Humboldtstr. (DE)

Correspondence Address: SCULLY, SCOTT, MURPHY & PRESSER, P.C., 400 GARDEN CITY PLAZA, SUITE 300, GARDEN CITY, NY, 11530, US

(73) Assignees: Fritz Haber Institut Der Max Planck Gesellschaft, Berlin (DE); NanoC Sdn. Bhd., 50400 Kuala Lumpur (MY)

(21) Appl. No.: 11/658,198

(22) PCT Filed: Jul. 22, 2005
(86) PCT No.: PCT/EP05/08022

§ 371 Date: Apr. 26, 2007

(30) Foreign Application Priority Data
Jul. 22, 2004 (EP) 04017308.0

(51) Int. Cl. B01J 23/00

(52) U.S. Cl. 502/321; 502/304; 502/302

(57) ABSTRACT

The present invention concerns a method for the preparation of a metal oxide catalyst comprising of molybdenum (Mo), vanadium (V), tellurium (Te), and niobium (Nb) and having a modified surface structure, comprising the steps of (i) providing a calcined catalyst material comprising oxides of Mo, V, Te, and Nb, (ii) treating agent selected from water and an aqueous solution of an acid or a base. (iii) separating the treated catalyst from the treating agent; and further a catalyst, obtainable by this process, and the use of this catalyst in oxidation reactions of hydrocarbons or partially oxidized hydrocarbons.

### FIELD OF THE INVENTION

The present invention concerns a metal oxide catalyst and a method for the preparation thereof as well as the use thereof as a catalyst in the oxidation reaction of hydrocarbons or partially oxidized hydrocarbons. More specifically, the present invention concerns a modified catalyst comprising oxides of Mo, V, Te and Nb, a method for preparation thereof by treating a calcined catalyst material with an aqueous treating agent, and the use of the above catalyst as an oxidation catalyst in the preparation of oxidized hydrocarbons, and especially of acrylic acid and methacrylic acid.

### BACKGROUND ART

Bulk and supported mixed metal oxide catalysts are an important class of catalytic materials employed in numerous industrial processes. They are used as oxidation catalysts in many reactions, including the preparation of various basic chemical materials. Among them, unsaturated aldehydes and carboxylic acids, such as (meth)acrylic acid and esters thereof, are important starting materials for the production of a broad spectrum of oligomeric and polymeric products.

The production of unsaturated carboxylic acids by oxidation of an olefin is well known in the art. For example, acrylic acid may be prepared by oxidizing propane or propylene in the gas phase. Similarly, methacrylic acid can be prepared by gas phase oxidation of butene or butane. Alternatively, the oxidation could also be conducted using already partially oxidized intermediates as starting materials, such as acrolein or methacrolein.

Metal oxide catalysts used for the above types of reactions are manifold and are well known to the person skilled in the art. However, despite the fact that many different and suitable catalyst for the present type of catalytic oxidation are known, the conversion rate and/or the selectivity towards the desired product is not always satisfactory. As a result, the product yield (productivity) is oftentimes too low. Thus, continuous efforts are undertaken by many researchers to obtain catalysts showing an improved conversion rate and/or selectivity, and the provision of better catalysts is an ongoing challenge.

Among the known metal oxide catalyst also catalyst containing oxides of molybdenum, vanadium and tellurium (Mo—V—Te catalysts) are well known in the state of the art. Catalysts wherein the above metal oxides are supplemented with niobium oxide and optionally further metal oxide components are described in e.g. U.S. Pat. No. 5,380,933. Such catalysts also have been subject to scientific studies concerning the oxidative dehydrogenation of hydrocarbons, e.g. propane, as well as the selective oxidation to the respective acrylic acids, see Zhen Zhao et al., J. Phys. Chem. B 2003, 107, 6333-6342, and D. Vitry et al., Applied Catalysis A: General 251 (2003) 411-424.

The production of (meth)acrylic acid by a gas phase catalytic oxidation of a mixtures of propane/propene, or isobutene/isobutane is disclosed in U.S. Pat. No. 6,710,207.

In addition to research directed to improved catalyst compositions in terms of the nature and relative amounts of the catalyst constituents, attempts have been undertaken to improve the conversion and/or selectivity of a catalyst material by secondary finishing treatments. These treatments generally are conducted after the final calcination step of the commonly known processes for manufacturing metal oxide catalyst systems.

For example, DE-A-102 54 279 describes multimetal oxide catalysts containing oxides of Mo, V and at least three further metal elements obtained by firstly preparing a multimetal oxide material in a commonly known manner and then selectively dissolving the (catalytically inactive) k-phase with a suitable dissolution agent. In this manner, it is said that the catalytically active i-phase is isolated. As can be seen from the description and examples of DE-A-102 54 279 the selective dissolution treatment results in a modification of the bulk structure of the catalyst material, which becomes manifest in different X-ray diffraction patterns of the metal oxide material before and after the dissolution treatment, respectively. This process requires relatively aggressive dissolution agents and treatment temperatures. This may be disadvantageous under economical and ecological aspects.

### SUMMARY OF THE INVENTION

In view of the above situation it is an object of the present invention to provide an alternative process for the improvement of the conversion and/or selectivity of calcined metal oxide catalysts under mild conditions. Preferably, this process is connected with a reduction of environmentally detrimental waste materials.

Further, it is an object of the present invention to provide a new catalyst showing improved conversion rate and/or selectivity in the catalyzed oxidation of hydrocarbons, especially of propane, propene, butane (n- or iso-) or butene (n- or iso-), in the production of their oxidized products, in particular (meth)acrylic acid or esters thereof.

Also, there is provided the use of the above catalyst in the oxidation of hydrocarbons of partially oxidized hydrocarbons, preferably in the production of (meth)acrylic acid.

Thus, the present invention provides a method for the preparation of a metal oxide catalyst comprising oxides of molybdenum (Mo), vanadium (V), tellurium (Te) and niobium (Nb) and having a modified surface structure, comprising the steps of
(i) providing a calcined catalyst material comprising oxides of Mo, V, Te and Nb,
(ii) treating this material with a treating agent selected from water and an aqueous solution of an acid or a base.
(iii) separating the treated catalyst from the treating agent.

Hereinafter, step (ii) is partially also referred as “leaching treatment” for the sake of brevity. Preferred embodiments of the method of the present invention are as defined in the dependent claims 2-16.

Furthermore, a catalyst obtainable by the process of the present invention is provided, and the use of this catalyst in oxidation reactions of hydrocarbons or partially oxidized hydrocarbons.

Preferred embodiments of the present catalyst and its use are as defined in the dependent claims 18-24.

### BRIEF DESCRIPTION OF THE FIGURES

FIG. 1 shows a transmission electron micrograph (TEM) of the catalyst prepared in example 1 after the final calcination, but prior to the “leaching” treatment in accordance with the present invention. In FIG. 1 a circle highlights an area where presumably a segregation process as explained below has led to the deposition of metal oxide material which is particulary suitable for the leaching treatment according to the present invention.

FIG. 2 shows a transmission electron micrograph (TEM) of a catalyst (example 1) after the leaching treatment in accordance with the present invention. In FIG. 2, the modified surface regions are recognizable as one larger darker area to the right of the micrograph and in the form of numerous darker hemispherical patches (regions) spread over the remaining surface area.

FIG. 3 shows a scanning electron micrograph (SEM) of a catalyst (example 1) after the leaching treatment in accordance with the present invention. FIG. 3 shows the major part of one grain in a preferred structure of the claimed catalyst.

FIG. 4 shows the increase in conductivity in the treatment agent (water) with time caused by the partial dissolution of the catalyst surface during the leaching process of the invention in comparison to a MoO₃ reference.

FIG. 5 shows the Mo concentration (mg/l) in the treatment agent (water) as determined by atomic absorption spectroscopy (AAS) against the duration of treatment (in min).

FIG. 6 shows XRD measurements of catalysts after different treatments indicating that the bulk structure is not significantly affected by the different treatments.

### DETAILED DESCRIPTION

In the process of the present application the catalyst to be treated, i.e. to be leached in accordance with the invention may be any known metal oxide catalyst comprising oxides of Mo, V, Te and Nb that has been calcined according to any commonly known processes. The methods for the preparation of such catalysts are generally well known. For details, reference may be made to the prior art cited herein above, and especially DE-A-102 54279 and the prior art documents cited therein, see especially page 5 [0043].

Further processes for preparing a multimetal oxide catalyst including Mo—V—Te—Nb metal oxide catalysts are disclosed in EP-A-0 962 253. The methods and materials applied therein to prepare a calcined metal oxide material can be applied in analogous manner in the present invention as well.

However, where the following description of the preparation of the catalyst to be treated deviates from the teaching of the prior art, it is preferred to adopt those conditions disclosed in the present application.

The catalyst of the present invention is a metal oxide material comprising the metal oxides of Mo, V, Te and Nb, and may optionally contain oxides of other metal elements, as long as these do not adversely affect the function of the resulting material as a catalyst in the oxidation reactions referred to herein. Preferably, the calcined catalyst material to be leached in the method of the present invention is a material of the average general formula (I):
MoVₐTe_{b}Nb_{c}Z_{d}Oₓ (I)
wherein a=0.15-0.50, b=0.10-0.45, in particular 0.10-0.40, c=0.05-0.20, d≦0.05 and x is a number depending on the relative amount and valence of the elements different from Oxygen in formula (I), and Z is at least one element selected from Ru, Mn, Sc, Ti, Cr, Fe, Co, Ni, Cu, Zn, Ga, Y, Zr, Rh, Pd, In, Sb, Ce, Pr, Nd, Te, Sm, Tb, Ta, W, Re, Ir, Pt, Au, Pb, and Bi. “Average” composition means the composition as can be determined with techniques such as XRF suitable for analyzing the bulk elemental composition.

Preferably, in formula (I) a=0.30-0.40, b=0.15-0.30, c=0.07-0.16, and d=0.03 or less, more preferably a=0.25-0.35, b=0.20-0.25, c=0.09-0.14 and d=0.01 or less.

According to one preferred embodiment of the present invention d is 0 in formula (I).

If in the compound of the formula (I) the at least one optional element Z is present (i.e. d>0), it is preferably at least one element selected from Ru, Mn, Cr, Fe, Co, Ni, Zr, Rh, Pd, In, Sb, Ce, Ta, W, Pt, and Bi. More preferred are compounds of formula (I), wherein Z, if present, is at least one element selected from Cr and Ni. Another preferred embodiment relates to the use of Ru, Cu, Rh, Re and/or Mn as Z element, Ru, Mn and Cu, in particular Ru and Mn being particularly preferred. If element Z is present, the lower limit of d is preferably 0.0005, in particular 0.001.

During the leaching treatment the catalyst undergoes at least a partial modification of its surface, while the bulk matter remains unchanged. It is further believed that the preferred calcination conditions explained below, more preferably the use of temperatures in the range of 550° to 700° C., even more preferably 580° C. to 670° C., in particular 630 to 660° C. during the final calcination step enhance the leaching process of the invention and thus the formation of catalytically very active “modified surface regions”.
(i) Without wishing to be bound be theory it is considered that a final calcination step under these conditions leads to chemical segregation processes with the aid of vapor phase transport phenomena where for instance steam and/or tellurium oxide may play a role and very small mixed metal oxide deposits form on the catalyst surface.
(ii) In the leaching step of the invention, the surface of the calcined catalyst is then at least partially leached and thus chemically modified, whereby deposits as preferably formed in step (i) seem to be particularly susceptible to this leaching.

As “modified surface region” we thus understand a surface region that can be distinguished from the bulk composition with respect to its chemical composition and preferably also its crystallinity by various analytical techniques as explained below in further detail. The modified surface of the claimed catalyst can comprise one or more modified surface regions.

The modified surface region may be present on the inner and/or outer surface of individual metal oxide catalyst particles. Preferably the outer surface area of the catalyst of the invention is greater than the inner surface area, the percentage of outer surface area being preferably at least 60%, more preferably at least 70%, in particular at least 85% of the total surface area. The specific surface area as measured according to the BET method with nitrogen is preferably 1 to 5 m²/g, in particular 2 to 4 m²/g.

There is no specific limitation regarding the size of the catalyst particles to be used. The following structural features are however preferred.

The macroscopic size (average longest diameter) of the individual catalyst particles preferably ranges from 0.5 to 10 mm. Catalyst particles of this size can be obtained by processes known in the art, for instance by pressing a dried catalyst starting material, newly crushing the pressed material and carrying out size-selecting steps such as sieving, before conducting at least one calcination step. Alternatively, the already calcined material is pressed, newly crushed and subjected to size-selecting steps such as sieving. Instead of pressing, an extrudate may be formed.

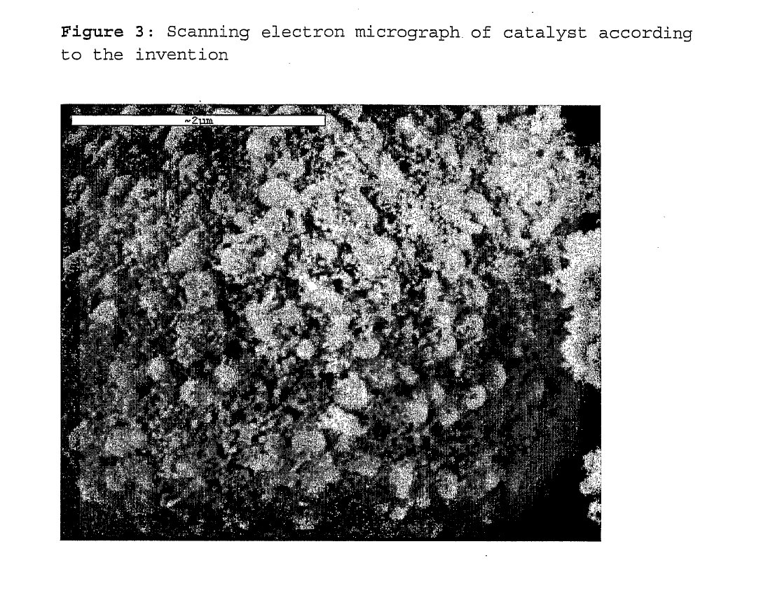

The macroscopic catalyst structure is preferably constituted by interconnected metal oxide grains. In electron microscopic pictures, such as FIG. 3, grains are easily distinguished by their essential spherical shape surrounded by pores. FIG. 3 shows the major part of one grain. The preferred size (average longest diameter) of these grains is from 2 to 100 μm, in particular 10 to 20 μm.

Each grain preferably comprises numerous aggregates of so-called “single crystalline domains” (SCDs). These aggregates are visible in FIG. 3 as granular structure within the catalyst grain shown (as mentioned before, several grains aggregate themselves to a macroscopic particle). SCDs are to be understood as the smallest coherent crystalline domain within the catalyst of the invention. These are preferably also surrounded by pores, which are naturally smaller than the pores surrounding the grains. SCDs can be analytically distinguished and visualized by electron microscopic techniques known in the art, preferably by transmission electron microscopic (TEM) analysis. The preferred size (average longest diameter) of SCDs ranges from 10 to 100 nm, in particular 50 to 200 nm. It seems that SCDs preferably adopt a platelet shape in the catalyst of the invention.

Preferably the “modified surface region(s)” generated according to the method of the present invention are located on the SCDs.

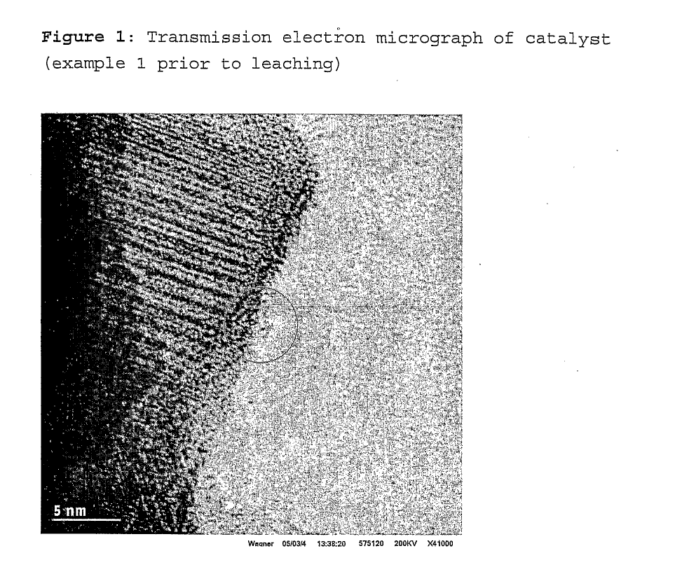

Depending on the size of the catalyst particle and its partial structure (grains, SCDs, etc.), the modified surface region preferably has a thickness of less than 15 nm, more preferably 0.1 to 10 nm, even more preferably 0.3 to 5 nm, in particular 0.5 to 2 nm (see FIG. 1). “Thickness” means here the extension of the modified surface region perpendicular to the surface area covered thereby.

As previously mentioned, the “modified surface region(s)” resulting from the treatment according to the invention, can cover the inner and outer surface area fully (100%) or partially (e.g. 0.1 to less than 100%, e.g. 1 to 99%, 5 to 95%, 10 to 90%, 20 to 80%, 30 to 70%, 40 to 60%).

In the latter case, the modified surface regions typically form patches (regions) having a longitudinal extension (average longest diameter) of preferably 1 to 20 nm, preferably on the unmodified surface SCDs. Their average diameter (longitudinal extension) is preferably at least as great as their thickness and may more preferably adopt at least the double value.

In the modified surface region, the present method results in a change of the chemical composition, preferably by selectively removing at least Mo from the catalyst material. Moreover, it seems to be preferred that the modified surface region is also depleted of V and/or Nb. The observed enrichment of Te in the modified surface region according to preferred embodiments of the invention may be caused by a slower dissolution of Tellurium oxide in the treatment agent as compared to the other metal oxides. The Te enrichment in the modified surface regions, in respect of the average bulk composition, may however also be accounted for by processes, which can already occur during the calcination as follows.

It is believed that under the preferred calcination treatment conditions of the present process, preferably at a final calcination temperature in the range of 550° to 700° C., more preferably 580° C. to 670° C., in particular 630 to 660° C., the bulk material may serve as a reservoir for chemically induced segregation processes under the action of a vapor phase transport agent such as tellurium oxide and/or steam (as preferably stemming from residual moisture in the material subjected to calcination). This segregation may contribute to the formation of the aforementioned modified, catalytically active surface regions. This mechanism may also explain the enrichment of Te in the modified surface regions. Further, there is the presumption that the other, catalytically less active surface areas are also influenced by this segregation, for instance by a possible Te depletion which may explain modulations of the crystalline lattice areas as partially seen in micrographs of the claimed catalyst.

Correspondingly, in line with these observations, it is preferred that a preferably thin, non-crystalline state of metal oxide material partially covering the crystalline bulk matter is created by the above-described segregation (see FIG. 1). It is believed that preferably the resulting surface regions of relatively disordered matter, as compared with the crystalline bulk material, after being subjected to the leaching process of the present invention, are responsible for a particularly strong increase of the catalytic activity of the catalysts of the invention.

Thus, as compared with the bulk, which remains unchanged, the chemical composition of the modified surface region(s) of the present catalyst (obtained by the present process) and preferably also their crystalline state are different.

The change of the chemical composition in the surface region can be determined by X-ray photoelectron spectroscopy. Further, analysis of the treating agent by atomic absorption spectroscopy will show which elements have been dissolved from the surface and their amounts. Additionally the enrichment of elements in the treating agent can be monitored by conductivity studies. The comparison with a reference material (e.g. MoO₃) will give indirect evidence which elements are preferably dissolved. It is also possible to analyze the treating agent by means of X-ray fluorescence spectroscopy. For this purpose the solution of elements in the treating agent can be mixed with starch and pressed into a pellet to be analyzed. Analysis of the untreated catalyst by the same method will show which elements have selectively dissolved.

According to the present invention, the change of the surface region is such that the Mo-content in the surface region of the obtained catalyst relative to the Mo-content prior to step (ii) of the present method is preferably lowered which can be seen from the relative intensities of the Mo peak in the treating agent and the remaining solid, as measured by X-ray fluorescence spectroscopy. Correspondingly the treating agent is enriched in Mo (for details please see example 1).

In comparison to the bulk material, the average surface composition as measurable by XPS preferably shows the following changes in elemental composition:
Mo: preferably a depletion of at least 1 atom %, more preferably 1 to 20 atom %, in particular 3 to 16 atom %,
V: preferably a depletion of 1 to 12 atom %, in particular 3 to 8 atom %,
Nb: preferably a depletion of 0.5 to 5 atom %, in particular 1 to 3 atom %,
Te: preferably an enrichment of 2 to 20 atom %, in particular 4 to 15 atom %,
   said values being based on the total amount of all metal atoms as 100% (of course, the degree of depletion depends on the amount of the respective element in the bulk composition and thus, even for the lower limits specified for the elements in the bulk composition, the depletion will not have the effect that respective element is depleted to 0 atom % in the average surface composition)

Without wishing to be bound by theory, it is believed that the preferred enrichment of Te in the modified surface regions results from the aforementioned segregation mechanism during calcination where possibly Te oxide(s) act as transport agent.

According to one embodiment of the invention, manganese-containing catalysts show a relative manganese enrichment in the average surface composition of preferably at least 5% manganese, more preferably 10 to 200%, e.g. 20 to 100% in comparison to the average bulk manganese composition.

The average depletion of Mo or other elements and the average enrichment of Te or other elements (such as Mn) at the surface can be verified by X ray photoelectron spectroscopy (XPS) whereas X-ray fluorescence spectroscopy (XRF) is one suitable technique for determining the bulk composition, as explained in the examples. It should be added that XRF measures the average bulk composition including the modified surface regions which, however, due to their minor proportion based on the entire bulk material do not affect the accuracy of this measurement. XPS measurements are suitable for determining the average outer surface composition of catalyst particles, typically up to a depth of about 1 nm.

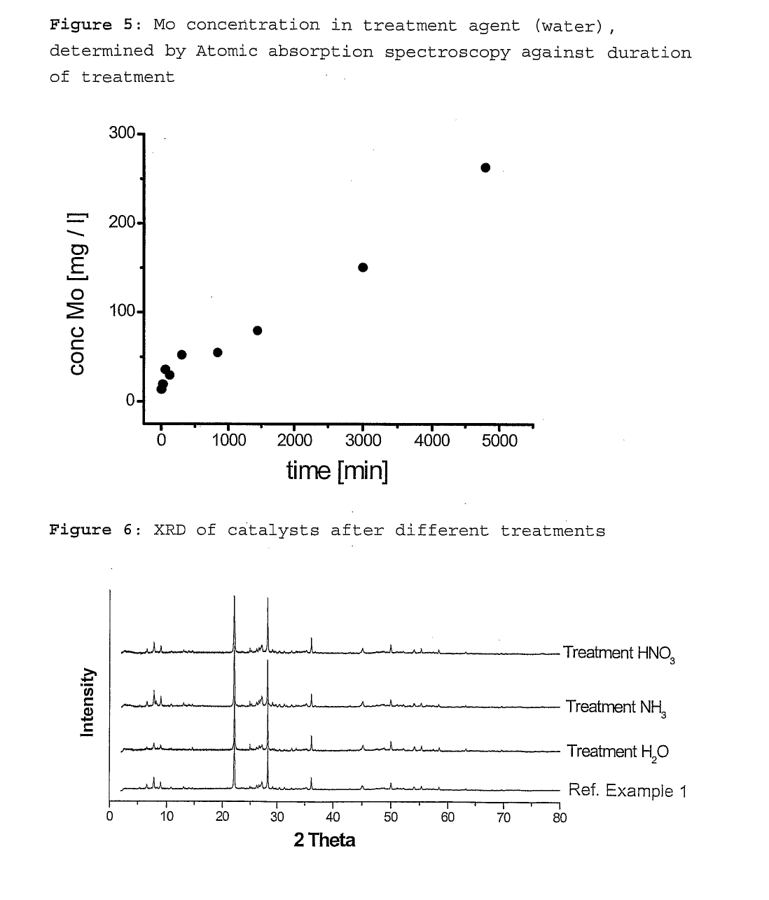

The enrichment of Mo or other elements in the treating agent can be verified with atomic absorption spectroscopy (please refer to FIG. 5).

The following Table 1 shows the average surface composition of various preferred catalysts of the invention, as measured by XPS.

TABLE 1
Average Surface Composition of Preferred Catalysts

| Sample number | | | | | | | |
|---|---|---|---|---|---|---|---|
| (and meaning of Z) | Mo | V | Te | Nb | Z | O | Si |
| 1 | 1 | 0,19 | 0,19 | 0,14 | — | 3,48 | — |
| 2 | 1 | 0,21 | 0,24 | 0,15 | — | 3,78 | — |
| 3 (Mn) | 1 | 0,18 | 0,31 | 0,11 | 0,01 | 3,68 | — |
| 4 (Mn) | 1 | 0,20 | 0,28 | 0,11 | 0,01 | 3,75 | — |
| 5 (Mn) | 1 | 0,19 | 0,26 | 0,11 | 0,01 | 3,70 | — |
| 6 | 1 | 0,20 | 0,24 | 0,15 | — | 3,69 | — |
| 7 | 1 | 0,24 | 0,42 | 0,11 | — | 5,78* | 17,8 |

*After deducting the oxygen content of SiO₂ diluent

The Z-free surface compositions were obtained from bulk material having the average composition Mo₁V_{0.30}Te_{0.23}Nb_{0.125}Oₓ and the manganese-containing surface compositions belong to a bulk-material having the composition Mo₁V_{0.30}Te_{0.23}Nb_{0.125}Mn_{0.005}Oₓ.

Among these, according to the present knowledge, the sample 3 achieves the best selectivities and yields in the propane conversion to acrylic acid. Ru-containing catalysts appear to show a similar performance.

Below the surface region basically no change is effected in the bulk material by the present method. This means that the bulk composition of the present catalyst obtained from the present process basically has the same bulk composition and structure as the starting material.

The term “substantially unchanged” in the present invention means that the X-ray diffraction pattern of the catalyst material prior to and after step (ii) of the present process is basically identical, and especially the relative intensity of the diffraction peaks at diffraction angles (2θ) of (22.2±0.5)°, (27.3±0.5)° and (28.2±0.5)° remains substantially unchanged. Also, the diffraction peak at a diffraction angle (2θ) 28.2±0.5° has an intensity which is not less than that of the diffraction peak at (27.3±0.5)°.

The experimental conditions under which the X-ray diffraction is measured are as follows: X-ray powder diffraction was carried out with A STOE STADI-P focusing monochromatic transmission diffractometer equipped with a Ge (111) monochromator and a position sensitive detector. Cu—Kα radiation was used.

The calcined catalyst material used as the starting material of the present method can be obtained according to any commonly known process. For example, solutions of suitable compounds of the metal elements (Mo, V, Te, Nb and any other optional element as defined above), as known in the art, are combined in predetermined ratios to obtain a metal element mixture corresponding to that of the desired catalyst, and then precipitating the metal element constituents by appropriate means to obtain solid material which can be subjected to a calcination.

Suitable starting materials for Mo, V, Te and Nb oxides are for instance those described in U.S. Pat. No. 5,380,933 (col. 3, line 27 to 57) and/or U.S. Pat. No. 6,710,207 (col. 8, lines 12 to 30), including the preferred ammonium para- or heptamolybdate, ammonium metavanadate, telluric acid and ammonium niobium oxalate. Preferably, a solution of the V source (e.g. an aqueous ammonium metavanadate solution) and a solution of the Te source (e.g. an aqueous solution of telluric acid) are added to a solution of the Mo source (e.g. an aqueous solution of ammonium heptamolybdate), preferably after heating the Mo solution, followed by the addition of the solution of a Nb source (e.g. an aqueous solution of ammonium niobium oxalate).

Similarly, a suitable starting material for the optional Z element can be selected by a skilled person from those used in the art. Mnaganese (Mn) can for instance be added as manganese acetate and ruthenium (Ru) as polyacid, for instance Mo-containing (optionally also P-containing) polyacids such as H₃PMo₁₁RuO₄₀.

According to one preferred embodiment of the present invention, the amounts of starting materials are adjusted as precisely as possible since this appears to have a great impact on the activity of the target catalyst. Preferably, the concentration (by mol) of each metal existing in the starting composition should not differ more than 1% from the calculated composition for a given catalyst system. Differences of not more than 0.5%, in particular not more than 0.1% by mol are more preferred. This can be achieved by verifying the actual content of the individual catalyst metal in the solutions used, e.g. by titration control and/or using metering devices for dosing the metal solutions as precisely as possible.

During or after the combination of solutions of the metal element compounds, a slurry is preferably formed or precipitated by addition of appropriate precipitating agents, and this slurry/precipitate is separated from the solvent by any suitable method known in the state of the art, such as filtration, spray drying, rotary evaporation, air drying (vacuum drying), or freeze drying.

It is preferred that the drying process does not eliminate any remaining moisture in the material to be calcined. Typically, the drying process (e.g. spray-drying) is terminated if the particles to be calcined do no longer agglomerate. Excessive drying is to be avoided in order to preserve residual moisture, which is believed to be beneficial in transport phenomena as explained before. Excessive drying occurs if the dried particles start to dust.

Solvents that can be used in the preparation of the catalyst material to be leached are not specifically limited, and preferred solvents include water, alcohols, preferably methanol, ethanol, propanol and butanol, diols, such as ethylene gylcol or propylene glycol, and other polar solvents, in particular water.

Further, any suitable mixture of the above solvents can be used.

Alternatively, metal oxides or metal compounds, which can be converted into oxides by calcination, can be mixed by dry mixing. In this case, the starting materials are preferably used in form of finely ground powders and may be further subjected to grinding treatment after combination with each other to further improve the mixing of the individual metal compounds.

In a preferred embodiment the catalyst precursor material can include a solid diluent. As diluent, any inert material, that can withstand the calcination conditions, does not interact with the metal oxide catalyst such that the catalytic activity thereof is impaired, and does not react with the starting materials, intermediates or final products of the oxidation reaction to be catalyzed by the present catalyst can be used.

The presence of a solid diluent is believed to be beneficial for various reasons. First of all, preferred diluents are characterized by a higher thermal conductivity than the catalytically active metal oxide material. This ensures a better heat transport management and prevents the formation of hot spots during the use of the catalyst, which could lead to undesired side reactions or lower the catalyst life. Secondly, the diluent functions as a separating agent for the catalytically active material and counteracts any sintering processes, which may occur between the grains of catalyst material. Further, the diluent may also improve the surface properties of the catalyst.

Preferred diluents include alumina, sulfated zirconium oxide (zirconia), cerium oxide (CeO₂), SiC and silica. Among them, silica is more preferred, and especially preferred is pyrogenic silica, e.g. pyrogenic silica having a BET specific surface area of 150-400 g/m², preferably 200-350 g/m². Explicit examples are silicas of the Aerosil® series, and especially suitable are Aerosil® 200 and Aerosil® 300. According to one preferred embodiment, the diluent is treated with a solution containing at least one metal, preferably at least one of the metals defined in formula (I), in particular Cr, Fe and/or Ni, prior to its admixture to the catalytically active metal oxide material or a starting material thereof. The resulting metal contents are 0.1 to 10 weight %, in particular 0.5 to 6 weight %, based on the weight of the dry diluent. For this purpose, the diluent is mixed with a suitable, preferably aqueous solution of a soluble metal salt, for instance a sulfate (e.g. a sulfate of Cr, Fe and/or Ni). The molarity of these solutions can be adjusted in view of the desired metal content, but ranges preferably from 0.01 to 0.5 mol/l, in particular 0.05 to 0.2 mol/l. After the pretreatment, the diluent is usually separated from the pretreatment agent and dried (preferred is a predrying at about 120° C., followed by a second drying step at 350 to 700° C., in particular 450 to 600° C.).

According to a second preferred embodiment, the diluent is subjected to a pretreatment with phosphoric acid (H₃PO₄) which is preferably conducted at higher temperatures, e.g. at 40 to 80° C., in particular 50 to 70° C. Preferably 5N to 7N H₃PO₄ (e.g. 6N) is employed for the pretreatment. After the pretreatment, the diluent is usually separated from the pretreatment agent and dried (preferred is a predrying at about 120° C., followed by a second drying step at 300 to 500° C.).

It is believed that these pretreatments of the diluent may further increase the catalytic activity and/or the selectivity of the claimed catalyst. Both pretreatments can also be combined.

Preferably the pretreated and dried diluent is subjected to the same first and second calcinations procedure, as described below for the catalyst material, before it is combined with the catalyst starting material. Thus, the pretreated diluent preferably undergoes these calcinations steps twice, once after the pretreatment and prior to mixing with catalyst starting material and a second time together with this catalyst starting material.

The amount of diluent, although not specifically limited, can be lower than commonly used in the preparation of catalysts supported on a carrier. Preferably the weight ratio of the diluent to the metal oxide catalyst component is not more than 3:1, more preferably not more than 2:1, even more preferably not more than 1.5:1 and especially not more than 1:1.

The diluent can be added at any time prior to the calcination procedure, i.e. it can be mixed with the metal oxide catalyst precursor components in a dry or a wet state or, if the catalyst precursor material is prepared using a solvent, it can be added to the solvent to precipitate the catalyst materials on the diluent in the process of preparing the catalyst precursor material.

Irrespective of which procedure is chosen and whether a diluent is present, the resulting solid material (catalyst precursor material) is then subjected to a first calcination in air or a synthetic oxygen-containing atmosphere at a temperature of 150-400° C., preferably 200-350° C., more preferably 250-300° C. Subsequently, preferably after an intermediate cooling step, a second thermal treatment is conducted under an inert atmosphere, preferably under nitrogen gas or argon gas, at a temperature of 350-700° C., more preferably 550-700° C., even more preferably 580-670° C., in particular 630 to 660° C. Specifically under atmospheric pressure, temperature ranges of 550 to 700° C., more preferably 580 to 670° C., in particular 630 to 660° C. are particularly suitable to induce chemical segregation processes on the catalyst surface which enhance the leaching step of the present invention. Any other combination of temperature and pressure (below or above atmospheric) achieving the same result is however similarly preferred. The calcination time in either step is not specifically limited, and may preferably be 0.5-30 h, more preferably 1-20 h and specifically 1-10 h for each calcination step.

The resulting calcined material is then subjected to the leaching treatment according to step (ii) of the method of the present invention. Thus, the calcined catalyst material is treated with water or an aqueous solution of an acid or a base and then separated from the treating agent to obtain a catalyst according to the present invention.

The treating agent of step (ii) is water or a dilute aqueous solution of an acid of or a base. If an aqueous solution of an acid or base is used, the preferred base is ammonia and preferred acids are nitric acid, sulfuric acid and oxalic acid. Preferably, the basic or acid solution is a dilute solution of 0.1 mol/l or less, more preferably 0.03 mol/l or less and especially 0.01 mol/l or less. With higher concentrations of base or acid, the risk seems to increase that catalytically active, modified surface regions are either not formed or quickly dissolved.

The pH of the treating agent may reside within the range of 1-13, preferably 3-11, more preferably 5-9. Most preferably the aqueous treating agent is water having a pH within the range of 6-8, preferably 6.5-7.5. Especially preferred as the treating agent of step (ii) is distilled water or deionized water.

The treatment of step (ii) is preferably conducted at a temperature of 10-40° C., more preferably 15-30° C. If water is used as the treating agent the treating temperature can be increased up to 80° C., but it is preferably 60° C. or less, and most preferably 40° C. or less as indicated above.

The treatment may be conducted for any period of time that gives rise to the desired surface region modification. Preferred treatment times may vary depending on the treating agent and the specific composition of the catalyst material. Also, a higher temperature normally allows for a shorter duration of the treatment. In general, the treatment may be performed for a period of 0.1-100 h, preferably 1-50 h, more preferably 2-24 h.

After the treatment of step (ii) the treated catalyst is separated from the treating agent, e.g. by filtration, decantation or other known means, optionally rinsed with water, and dried. The drying can for example be obtained by air drying, vacuum drying, freeze-drying, spray drying and other means known in the art. Suitable drying temperatures are room temperature as well as elevated temperatures, preferably 200° C. or less, more preferably 150° C. or less. The drying can be conducted at reduced pressure and/or in air or an inert gas such as nitrogen or argon.

The catalyst of the invention can be used under conventional conditions to convert hydrocarbons to their oxidized products. The reaction is preferably conducted in fixed bed reactors. For reasons of convenience, atmospheric pressure can be used whilst the reaction proceeds similarly under lower or higher pressures. Preferably, an inert gas (e.g. nitrogen) and/or steam are admixed to the hydrocarbon (e.g. propane) and oxygen. A standard feed composition is for instance propane/oxygen/nitrogen/steam of 1/2-2, 2/18-17, 8/9 (molar ratio). Preferred reaction temperatures range from 350-450° C. The molar amount of steam (H₂O) based on the total molar amount of hydrocarbon, O₂, inert gas (e.g. N₂) and steam (H₂O) can be varied considerably with the catalyst of the invention. Suitable results are achieved with molar amounts of preferably 5-65%, for instance 10-50%. Surprisingly, the catalyst of the invention seems to require lower molar steam amounts than typically used in the art (40%) since some of the best results have been achieved with steam amounts from 25-38%, in particular 28-35%.

In the following the present invention will be explained in more detail by reference examples as well as preparation examples and examples describing the use of the present catalyst in representative oxidation reactions.

### EXAMPLES

The following analytical techniques were used for evaluating catalysts of the present invention and reference catalysts.

Conductivity measurements were carried out with a conductometer WTW LF 530 with conductivity cell LTA1. The measurement was performed such that the conductivity electrode was introduced directly into the dispersion of catalyst and treating agent.

X-ray fluorescence measurements were carried out on a Seiko Instruments (SII) XRF machine. The remaining solid was measured directly, whereas the treating agent containing the dissolved samples was mixed with starch and pressed into a pellet.

Atomic absorption spectroscopy was carried out on a Perkin Elmer 4100 Atomic Absorption Spectrometer. A N₂O C₂H₂ flame and a slit width of 0.7 nm was used. A wavelength of 313.3 nm was used.

X-ray photoelectron spectroscopy (XPS) was carried out in a modified LHS/SPECS EA200 MCD system equipped with facilities for XPS (Mg Kα 1253.6 eV, 168 W power) and UPS (He I 21.22 eV, He II 40.82 eV). For the XPS measurements a fixed analyser pass energy of 48 eV was used resulting in a resolution of 0.9 eV FWHM. The binding energy scale was calibrated using Au 4f7/2=84.0 eV and Cu 2p3/2=932.67 eV. The base pressure of the UHV analysis chamber was <1.10-10 mbar. Quantitative data analysis was performed by subtracting stepped backgrounds and using empirical cross sections (Briggs and Seah “Practical Surface Analysis” second edition, Volume1-Auger and X-ray Photoelectron Spectroscopy, Appendix 6 p. 635-638).

X-ray powder diffraction (XRD) was carried out with A STOE STADI-P focusing monochromatic transmission diffractometer equipped with a Ge (111) monochromator and a position sensitive detector. Cu—Kα radiation was used.

Transmission electron microscopy (TEM) was conducted by directly preparing calcined samples onto standard meshed copper grid coated with a holey carbon film. The samples were studied in a Philipps CM 200 FEG TEM operated at 200 kV and equipped with a Gatan Image Filter and a CCD camera.

Scanning electron microscopy (SEM) images are acquired with an S 40000 FEG microscope (Hitachi). The acceleration voltage is set to 5 kV and the working distance to 10 mm.

### Reference Example 1

A catalyst with the desired approximate composition of Mo₁V_{0.30}Te_{0.23}Nb_{0.12}Ox was prepared in a similar manner as described in EP 0 962 253 A2. The procedure is illustrated in table 2 below. Dissolving ammonium heptamolybdate, ammonium metavanadate and telluric acid in 100 ml of bidistilled water (solution 1) resulted in a deep red solution of pH=4.5. The addition of ammonium niobium oxalate solution to the first solution led to the precipitation of a slurry after a short induction time, as described in EP 0 962 253 A2. This slurry was spray-dried with a Büchi B191 Mini Spray dryer at a temperature of 220° C.

The spray-dried material was molded by a tabletting machine to a tablet of about 13 mm in diameter and 2 mm in length, which was then crushed (with a mortar) and sieved to obtain particles having an average diameter of 0.8 to 1 mm.

These particles were first heated in static air from 30° C. to 275° C. (temperature increase rate of 10 K/min) followed by one hour at 275° C. and then again cooled down to 30° C., before the material was heated to 600° C. in flowing helium (temperature increase rate of 2 K/min) and kept at this temperature for two hours.

TABLE 2

| | | Amount | |
|---|---|---|---|
| | Precursor | (g) | Remarks |
| Sol. 1 | Ammmonium heptamolybdate | 11.27 | Dissolved in H₂O |
| | tetrahydrate (Merck) | | (100 ml) |
| | Ammonium metavanadate | 2.24 | Added after heating |
| | (Riedel de Haen) | | the molybdate |
| | Telluric acid (Aldrich) | 3.37 | solution to 80° C. |
| Sol. 2 | Ammonium niobium oxalate | 3.53 | Dissolved in H₂O |
| | (Aldrich) | | (30 ml) |

The XRD of the resulting catalyst is shown in FIG. 6 as the lowest curve.

### Reference Example 2

Catalyst particles having an average diameter of 0.8 to 1 mm were prepared in the same manner as described in reference example 1, apart from the following changes.

Solution 1 was prepared according to Reference Example 1. 14.29 g of Aerosil 300 (Degussa) were added thereto. The resulting dispersion was combined with solution 2 and spray dried, as described above. Calcination was carried out under the same conditions as mentioned above, but with a final temperature of 325° C. for the precalcination and 650° C. for the main calcination.

### Example 1

Catalyst particles having an average diameter of 0.8 to 1 mm were prepared in the same manner as described in reference example 1, apart from the following changes.

After a precalcination step and intermediate cooling under the conditions described, the material was heated to 650° C. in flowing helium (temperature increase rate of 2 K/min) and kept at this temperature for two hours.

A TEM of the resulting catalyst particles (not yet leached) is shown in FIG. 1.

After the final calcination step the material obtained was dispersed in 0.5 l of water. The dispersion was stirred at room temperature for 24 hours. After this treatment the solid material was separated from the liquid by centrifugation. It was dried in a desiccator over P₂O₅.

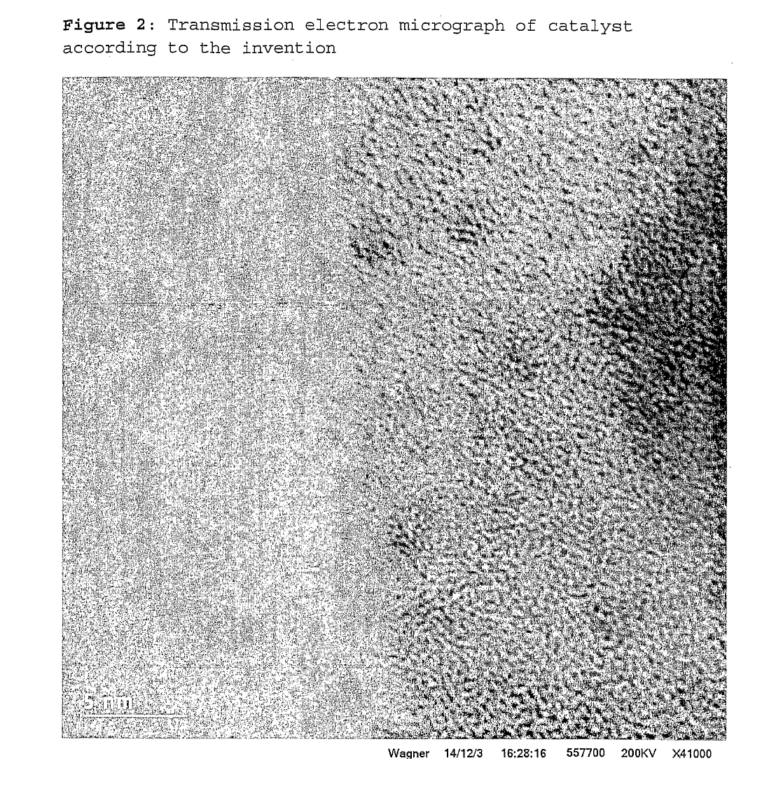

From the catalyst obtained TEM and SEM micrographs were taken which are shown as FIGS. 2 and 3, respectively. The XRD of this catalyst is shown in FIG. 6.

For analytical purposes the above procedure was repeated with the sole difference that the water treatment was interrupted after 1 hour. Then, the elemental composition of the treatment agent (water) and the solid treated catalyst particles was determined by XRF analysis under the previously described conditions. The results are shown in table 3.

Furthermore, the surface composition of the catalyst (1 hour water treatment) was determined by XPS which led to the results shown in table 4.

TABLE 3
Elemental composition of treatment agent and remaining solid
determined by XRF Analysis (Treatment in H₂O for one hour)

| | solid material | | treatment |
|---|---|---|---|
| Element (At %) | Ref. Ex. 1 | Example 1 | agent |
| Mo | 64,1 | 61,7 | 89.4 |
| V | 15,1 | 14,9 | 0.7 |
| Nb | 7,6 | 7,4 | 2.8 |
| Te | 13.1 | 15.5 | 7.0 |

It is thus seen that, within the accuracy of the XRF method (about ±2%), the bulk composition of the catalyst has not changed after the leaching treatment of the invention. Further, the composition of the treating agent clearly indicates the preferential extraction of Mo from the catalyst surface.

TABLE 4
Elemental composition of the surface of the catalyst
determined by XPS

| | Ref. Example 1 | Example 1 |
|---|---|---|
| | (atom % based on | (atom % based on |
| Element | all metallic elements) | all metallic elements) |
| Mo | 65,7 | 60,8 |
| V | 12,5 | 8,6 |
| Nb | 9,3 | 7,2 |
| Te | 12,5 | 23,4 |

These XPS measurements, which can be performed with an accuracy of about +0.5%, thus confirm the results of table 3 insofar as Mo (as well as V and Nb) were selectively dissolved.

### Example 2

Catalyst particles were prepared as described in Reference Example 2 with the exception of the following changes.

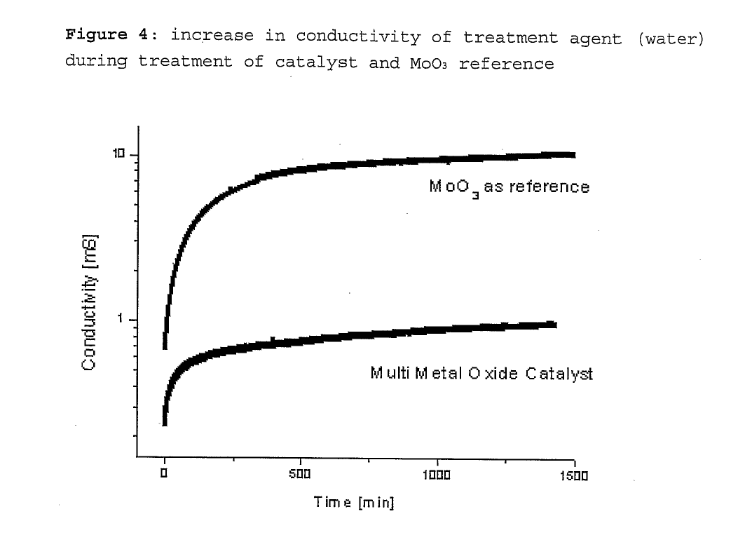

After the final calcination, the catalyst particles were dispersed in 0.5 l of water. The dispersion was stirred at room temperature for 24 hours and the conductivity monitored under the above-described conditions. As reference sample MoO₃ (available from Aldrich, particle size 2 to 10 μm) was stirred with water while monitoring the conductivity increase of the water. The results are shown in FIG. 4.

After the treatment the solid catalyst material was separated from the liquid by centrifugation. It was dried in a dessicator.

### Example 3

Treatment of the catalyst was carried out as described in Example 1, but 0.1M HNO₃ was used instead of water. The XRD of the resulting catalyst is shown in FIG. 6.

### Example 4

Treatment of the catalyst was carried out as described in Example 1, but 0.1M NH₃ solution was used instead of water. The XRD of the resulting catalyst is shown in FIG. 6. The comparison of the XRD peaks measured for reference example 1 and examples 1, 3 and 4 indicates that the bulk structure of the catalyst of the invention does not undergo any substantial changes during the treatment with water, ammonia solution or HNO₃ solution.

### Example 5

Catalyst particles having an average diameter of 0.8 to 1.0 mm and the same chemical composition (Mo₁V_{0.30}Te_{0.23}Nb_{0.125}O_{X}) were prepared as described in Reference example 1 apart from the following changes.

The batch size was substantially increased (100 g nominal yield after calcination) and measures were taken to keep the chemical composition constant from batch to batch. “Constant” means that between batch sizes there is no discernible difference in the bulk chemical composition within the limits of XRF errors.

Table 5 shows the chemicals and amounts of salts used. In contrast to reference example 1, not only one solution containing the Mo, V and Te components was prepared and combined with the Nb solution, but rather four individual solutions were prepared. The concentrations of these solutions were determined and verified by complexometric titration of EDTA solution (0.01 M) with EBT as indicator.

The total amount of water used was adjusted such as to provide a precipitation reaction within about 1 to 5 min after addition of the Nb solution to the clear solution obtained after combining the three other components.

The available volume of water (see table 5) was divided equally among the Mo, V and Te metal salt solutions.

Moreover, the four metal salt solutions used were found to contain micro-crystallites showing Tyndall effects ranging from intense (V solution) to faint (Nb Solution). In direct optical inspection all solutions were however clear.

TABLE 5
Chemicals used in preparation.

| | | | | | | | | | |
|---|---|---|---|---|---|---|---|---|---|
| | | | wt | wt of | Conc | Mol of | | wt of | Conc |
| Name | Molecular Formula | MW | (g) | H₂O (g) | (M) | metal | ratio | H₂O (g) | (M) |

Solution 1

| | | | | | | | | | |
|---|---|---|---|---|---|---|---|---|---|
| Ammonium | (NH₄)₆Mo₇O₂₄•4H₂O | 1235.86 | 47.18 | 771.00 | 0.0495 | 0.2672 | 1.00 | 257.00 | 0.1485 |
| Heptamolybdate | | | | | | | | | |
| Ammonium | NH₄VO₃ | 116.98 | 9.38 | 771.00 | 0.1040 | 0.0802 | 0.30 | 257.00 | 0.3120 |
| Metavanadate | | | | | | | | | |
| Telluric Acid | H₂TeO₄•2H₂O | 229.64 | 14.12 | 771.00 | 0.0798 | 0.0615 | 0.23 | 257.00 | 0.2393 |

Solution 2

| | | | | | | | | | |
|---|---|---|---|---|---|---|---|---|---|
| Ammonium | C₁₀H₈N₂O₃₃Nb₂ | 870.00 | 15.36 | 216.00 | 0.0817 | 0.0353 | 0.13 | 216.00 | 0.0817 |
| Niobium Oxalate | | | | | | | | | |
| Oxalic acid | (COOH)₂ | 126.07 | 5.34 | | 0.1961 | | | | |

To combine the four solutions, a precipitation reactor was used which was equipped with computer-controlled peristaltic pumps. These allowed dosing the volumes of the four solutions in such a way that the exact stoichiometry reported in table 1 reproducibly existed.

Each metal salt solution was pumped into the reactor vessel sequentially by a peristaltic pump. An orange slurry formed 5 min after the addition of solution 2.

The work-up and calcinations were performed as described in reference example 1. The final calcination conditions were chosen to be 3 h at 600° C. for undiluted material and 3 h at 650° C. for materials supported on Aerosil 300. Leaching was performed in both cases over 48 hours at 300 K with 31 of pure water to account for the increased batch size of this example.

The bulk analysis data of example 5, as measured by XRF, were Mo 70.75%, V 17.48%, Nb 9.24%, Te 11.47%.

This catalyst (undiluted) was evaluated under the conditions shown in example 8 and led to the conversion, selectivity and yield values shown in table 6.

If the calcination of undiluted material was performed at higher temperatures than 600° C. (e.g. 650° C.), a further improved performance was noticed.

### Example 6

Catalyst particles were prepared under the same conditions as in Example 5 except for filtering the same metal salt solutions over a membrane (0.45 micron) prior to mixing. The “same” means that the corresponding solutions were divided in two, one being used in example 5 and the second one after filtration in the present example.

The bulk analysis data of the resulting catalyst composition, as measured by XRF, were Mo 68.12%, V 8.56%, Nb 7.61%, Te 15.31%.

This catalyst (undiluted) was evaluated under the conditions shown in example 8 and led to the conversion, selectivity and yield values shown in table 6. In all three aspects example 6 is inferior to example 5.

In comparison with example 5, it is thus seen that the filtration step apparently has removed microparticles from the previously analyzed solutions and thereby some of the metal ions used for catalyst construction. The fraction of metal ions differed considerably in examples 5 and 6. Accordingly, in view of the aim to adjust a given catalyst composition as precisely as possible, it is not preferred in the present invention to subject the starting metal solutions to filtration steps.

### Example 7

An undiluted manganese-containing catalyst having the bulk composition Mo₁V_{0.30}Te_{0.23}Nb_{0.125}Mn_{0.005}Oₓ and the average surface composition MoV_{0.18}Te_{0.31}Nb_{0.11}Mn_{0.01}O_{3.68} was prepared in the same manner as described in example 5 (including a leaching time of 48 h) with the difference that the required amount of aqueous manganese acetate solution was added to the Mo-containing solution prior to mixing and the final calcination (over 3 h) was conducted at 650° C.

This catalyst was evaluated under the conditions shown in example 8 and led to the particularly excellent conversion, selectivity and yield values shown in table 6.

### Example 8

The performance of various catalysts over that of reference example 1 was evaluated in the following oxidation process.

A tubular flow reactor having an inner diameter of 10 mm was filled with 0.55 g of each of the catalysts that were prepared according to reference example 1 or the examples given in table 6 below, respectively. The volume of the catalyst bed was about 0.5 ml and the packing density of the catalyst 1.103 g/ml.

Then propane, oxygen (O₂), nitrogen (N₂) and steam (H₂O) were supplied into the reactor under atmospheric pressure and in a molar ratio of 1:2:18:9 (P/O₂/N₂/H₂O), respectively, and at a temperature as given in table 6 below. The total flow of gases was 10.05 mlN/min (N=normal, i.e. at atmosheric pressure) and the GHSV (gas hourly space velocity) corresponded to 1200/h (STP, standard temperature pressure conditions).

At the reactor outlet, the produced gases were analyzed by GC and the conversion of propane and the selectivity for acrylic acid calculated. The results are shown in the following table 6.

TABLE 5
Catalytic performance

| | | propane | selectivity | acrylic |
|---|---|---|---|---|
| catalyst | temperature | conversion | for acrylic acid | acid yield |
| Ref. Ex. 1 | 400° C. | 12 | 43 | 5,2 |
| Example 1 | 400° C. | 43 | 64 | 27,5 |
| Example 2 | 400° C. | 59 | 64 | 37,8 |
| Example 2 | 410° C. | 61 | 68 | 41,5 |
| Example 5 | 400° C. | 62 | 73 | 44,9 |
| Example 6 | 400° C. | 52 | 27 | 14,2 |
| Example 7 | 400° C. | 72 | 70 | 50,4 |

As can be seen from the results in Table 6, the method of the present invention provides catalysts leading to increased conversion rates and/or selectivities and thus to an improved yield of the target product in the oxidation reaction of hydrocarbons, such as propene, propane, butene or butane to (meth)acrylic acid.

Thus, the present method and catalyst can advantageously be applied in industrial processes such as the preparation of unsaturated carboxylic acids by catalyzed oxidation reactions.

1. Method for the preparation of a metal oxide catalyst comprising oxides of molybdenum (Mo), vanadium (V), tellurium (Te) and niobium (Nb) and having a modified surface structure, comprising the steps of
(i) providing a calcined catalyst material comprising oxides of Mo, V, Te and Nb,
(ii) treating this material with a treating agent selected from water and an aqueous solution of an acid or a base.
(iii) separating the treated catalyst from the treating agent.

2. Method of claim 1, wherein the catalyst material provided in step (i) is a material of the general formula (I):
MoVₐTe_{b}Nb_{c}Z_{d}Oₓ (I)
wherein a=0.15-0.50, b=0.10-0.40, c=0.05-0.20, d≦0.05 and x is a number depending on the relative amount and valence of the elements different from Oxygen in formula (I), and Z is at least one element selected from Ru, Mn, Sc, Ti, Cr, Fe, Co, Ni, Cu, Zn, Ga, Y, Zr, Rh, Pd, In, Sb, Ce, Pr, Nd, Te, Sm, Tb, Ta, W, Re, Ir, Pt, Au, Pb, and Bi.

3. Method of claim 2, wherein Z is present and selected from Ru and Mn.

4. Method of claim 2 or 3, wherein in formula (I) a=0.30-0.40, b=0.15-0.30, c=0.07-0.16, and d≦0.03.

5. Method of claim 4, wherein a=0.25-0.35, b=0.20-0.25, c=0.09-0.14, and d≦0.01.

6. Method of any of claims 2, 4 or 5, wherein in formula (I) Z is at least one element selected from Cr, Fe, Co, Ni, Zr, Rh, Pd, In, Sb, Ce, Ta, W, Pt, and Bi.

7. Method of any of claims 2 and 4 to 6, wherein in formula (I) d=0.

8. Method of any of claims 1-7, wherein step (ii) is conducted by suspending the catalyst material of step (i) in the treating agent under stirring.

9. Method of any of claims 1-8, wherein the treating agent is an aqueous solution of an acid, selected from nitric acid, sulfuric acid, and oxalic acid, or an aqueous ammonia solution.

10. Method of any of claims 1-9, wherein step (ii) is conducted at a temperature of 0-40° C.

11. Method of any of claims 1-8, wherein the treating agent is water.

12. Method of claim 11, wherein the water is selected from tap water, distilled water, and ion-exchanged water.

13. Method of claim 11 or 12, wherein step (ii) is conducted at a temperature of 0-80° C.

14. Method of any of claims 1-13, wherein step (ii) is conducted for a period of 0.1-100 h.

15. Method of any of claims 1 to 14, wherein the step of providing a calcined catalyst involves a final calcination step at a temperature of 550 to 700° C., more preferably 580 to 670° C., in particular 630 to 660° C.

16. Method of claim 15, wherein the catalyst starting material to be calcined comprises residual moisture.

17. Catalyst, obtainable by a process according to any of claims 1-16.

18. Catalyst of claim 17, wherein the bulk structure after step (ii), measured by X-ray diffractometry, is substantially unchanged as compared with the bulk structure prior to step (ii).

19. Catalyst of claim 17 or 18, comprising at least one modified surface region, which is depleted in the Mo-content relative to the average Mo composition of the bulk structure.

20. Catalyst of claim 19, wherein the average Mo surface content, as measurable by XPS, is by 1 to 20 atom % lower than the average Mo content of the bulk structure, based on a total metal composition of 100 atom %.

21. Catalyst of any of claims 17 to 20 comprising at least one modified surface region, which is enriched in the Te-content relative to the average Te composition of the bulk structure.

22. Catalyst according to any of claims 17 to 19, comprising manganese.

23. Catalyst according to claim 22 comprising at least one modified surface region, which is enriched in the Mn-content relative to the average Mn composition of the bulk structure.

24. Catalyst according to claim 22 or 23 comprising at least one surface region having the average composition of MoV_{0.18}Te_{0.31}Nb_{0.11}Mn_{0.01}O_{3.68}.

25. Use of the catalyst of any of claims 17-24 as a catalyst in oxidation reactions of hydrocarbons or partially oxidized hydrocarbons.

26. Use of claim 25, wherein the hydrocarbons or partially oxidized hydrocarbons are selected from propane, butane, propene, butene and (meth)acrolein.

27. Use of claim 25 or 26, wherein the oxidized product of the oxidation reaction is acrylic acid or methacrylic acid.
